(19) United States
(12) Patent Application Publication
(10) Pub. No.: US 2025/0388117 A1
(43) Pub. Date: Dec. 25, 2025

(54) MOVABLE POWER VEHICLE CHARGING SERVICE

(71) Applicant: INTERNATIONAL BUSINESS MACHINES CORPORATION, Armonk, NY (US)

(72) Inventors: Zhan Peng Huo, Beijing (CN); Yu Li, Beijing (CN); Han Wen Zhu, Beijing (CN); Si Ming Zhu, BEIJING (CN); Chun Hong Zheng, Beijing (CN); Su Liu, Austin, TX (US)

(21) Appl. No.: 18/753,455

(22) Filed: Jun. 25, 2024

(51) Int. Cl. B60L 53/68; B60L 53/57

(52) U.S. Cl. CPC B60L 53/68; B60L 53/57

(57) ABSTRACT

A computer-implemented method for receiving electric vehicle (EV) data describing at least one connected electric vehicle and at least one portable electric vehicle charging (PEVC) unit and analyzing the received data to determine at least one PEVC demand requirement and at least one PEVC ride-sharing supply. The method may further include assigning an identified PEVC carrier to deliver a PEVC unit to a target PEVC end user and transmitting at least one delivery instruction to the assigned PEVC carrier and the target PEVC end user. The method may further include receiving a confirmation message from the assigned PEVC carrier that the PEVC unit was delivered to the target PEVC end user.

### BACKGROUND

Aspects of the present invention relate generally to systems and methods for improving electric vehicle (EV) charging. Specifically, aspects of the present invention provide a movable power vehicle charging (MPVC) service system and method configured to analyze vast amounts of EV data, including internet-of-things (IoT) data, and schedule, assign, and manage portable electric vehicle charger (PEVC) unit deliveries to EVs needing a charge.

The EV charging infrastructure has seen significant growth and evolution over the past decade, driven by the increasing adoption of EVs and the global push towards sustainability. Governments worldwide have implemented policies and incentives to promote the development of EV charging networks, aiming to reduce greenhouse gas emissions and dependency on fossil fuels. In the United States, government programs have set ambitious targets, including a goal to install 500,000 public EV chargers by 2030. Europe, particularly countries like Norway and Germany, has also made substantial investments in EV infrastructure, with extensive networks of fast chargers. China, the world's largest EV market, has rapidly expanded its charging network, boasting over 800,000 public charging points by the end of 2022.

Urban areas are generally better equipped with a dense network of public charging stations, including fast chargers, due to higher population densities, more robust electrical grids, and greater investment from both public and private sectors. This accessibility facilitates convenient and frequent charging, supporting urban residents who may not have personal garages for home charging. Rural areas typically have fewer charging stations, longer distances between them, and lower adoption rates of EVs, partly due to the extended driving ranges needed and the lesser availability of public charging options.

### SUMMARY

In a first aspect of the invention, there is a computer-implemented method including: receiving, by a processor set, electric vehicle (EV) data describing at least one connected electric vehicle and at least one portable electric vehicle charging (PEVC) unit; analyzing, by the processor set, the received data to determine at least one PEVC demand requirement and at least one PEVC ride-sharing supply; assigning, by the processor set, an identified PEVC carrier to deliver a PEVC unit to a target PEVC end user; transmitting, by the processor set, at least one delivery instruction to the assigned PEVC carrier and the target PEVC end user; and receiving, by the processor set, a confirmation message from the assigned PEVC carrier that the PEVC unit was delivered to the target PEVC end user.

In another aspect of the invention, there is a computer program product including one or more computer readable storage media having program instructions collectively stored on the one or more computer readable storage media. The program instructions are executable to: receive electric vehicle (EV) data describing at least one connected electric vehicle and at least one portable electric vehicle charging (PEVC) unit; analyze the received data to determine at least one PEVC demand requirement and at least one PEVC ride-sharing supply; assign an identified PEVC carrier to deliver a PEVC unit to a target PEVC end user; transmit at least one delivery instruction to the assigned PEVC carrier and the target PEVC end user; and receive a confirmation message from the assigned PEVC carrier that the PEVC unit was delivered to the target PEVC end user.

In another aspect of the invention, there is a system including a processor set, one or more computer readable storage media, and program instructions collectively stored on the one or more computer readable storage media. The program instructions are executable to: receive electric vehicle (EV) data describing at least one connected electric vehicle and at least one portable electric vehicle charging (PEVC) unit; analyze the received data to determine at least one PEVC demand requirement and at least one PEVC ride-sharing supply; assign an identified PEVC carrier to deliver a PEVC unit to a target PEVC end user; transmit at least one delivery instruction to the assigned PEVC carrier and the target PEVC end user; and receive a confirmation message from the assigned PEVC carrier that the PEVC unit was delivered to the target PEVC end user.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIGS. 3A-3B show a flowchart of an exemplary method in accordance with aspects of the present invention.

FIG. 4 shows a block diagram of an exemplary environment in accordance with aspects of the present invention.

FIG. 5 shows a block diagram of an exemplary environment in accordance with aspects of the present invention.

FIG. 6 shows a diagram of an exemplary environment in accordance with aspects of the present invention.

FIG. 7 shows a diagram of an exemplary environment in accordance with aspects of the present invention.

FIG. 8 shows a table of an exemplary data structure in accordance with aspects of the present invention.

### DETAILED DESCRIPTION

Aspects of the present invention relate generally to systems and methods for improving EV charging and, more particularly, to an MPVC service system and method configured to analyze vast amounts of EV data, including IoT data, and schedule, assign, and manage PEVC unit deliveries to EVs needing a charge.

According to an aspect of the invention, there is a computer-implemented method and system for MPVC service with IoT data analysis. The method and system include monitoring and collecting IoT data of EV battery conditions, user routing plans, current user location and target destination from all involved EVs in a vehicle-to-everything (V2X) network; analyzing charging demands and ride-sharing willingness from collected data; and identifying potential portable EV charger carriers and target EV charger end users. The method and system may further include broadcasting charging and ride-sharing requirements to identified potential portable EV charger carriers and target EV charger end users; matching the responded portable EV charger carriers and target EV charger end users; and suggesting optimal charging option based on current battery condition, service profile and user profile. In embodiments, the method and system may further include assigning the delivery tasks to portable EV charger carriers and confirming the deployed delivering tasks with the matched EV charger end users and delivering the portable EV charger to the EV charger end user to complete the charging. In embodiments, the method and system may further include calculating the battery rental cost, delivery cost, and sharing credits for participants; generating payment plans based on the calculated battery rental cost, delivery cost, and sharing credits for collecting payments; and paying the related participants; and returning the portable EV charger.

In embodiments, the method and system may further include enabling running time charging (wired/wireless) for both portable EV charger carrier and the target EV charger end user; and may also allow users (PEVC carriers and target PEVC end users) to choose preferred partners. In embodiments, the method and system may optionally define a portable EV charger method (ride-sharing PEVC service) framework to carry and share a portable EV charger among EVs. In embodiments, the method and system may optionally define a new data structure to track, save, and process PEVC related data; and collect and monitor IoT data in PEVC client and from PEVC server. As used herein, PEVC data may include PEVC end user data, travel options (i.e., fastest route, cheapest route, scenic route), PEVC provider data, ride-sharing mode, target point of the PEVC end user, charger return point of the PEVC end user, PEVC carrier data, current point of PEVC carrier, PEVC unit picking point of PEVC carrier, target point of PEVC carrier, PEVC service status, PEVC charging fee discount, road time, estimated waiting time at nearest charging station, and more.

Implementations of the invention are necessarily rooted in computer technology. For example, the steps of receiving EV data describing at least one connected electric vehicle and at least PEVC unit; analyzing the received data to determine at least one PEVC demand requirement and at least one PEVC ride-sharing supply; assigning an identified PEVC carrier to deliver a PEVC unit to a target PEVC end user; and transmitting at least one delivery instruction to the assigned PEVC carrier and the target PEVC end user are computer-based and cannot be performed in the human mind. Using a machine learning model is, by definition, performed by a computer and cannot practically be performed in the human mind (or with pen and paper) due to the complexity and massive amounts of calculations involved when training the model and when using the trained model to generate an output in real time (or near real time). Given this scale and complexity, it is simply not possible for the human mind, or for a person using pen and paper, to perform the number of calculations involved in training and/or using a machine learning model.

It should be understood that, to the extent implementations of the invention collect, store, or employ personal information provided by, or obtained from, individuals (for example, driving habits and preferences, real-time location(s), payment information, and/or contact information), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

EV drivers are increasing rapidly and because there are more EV drivers and more EV vehicles on the road, more EV charging stations are needed. Unfortunately, however, infrastructure and maintenance costs of these charging stations are high. There are currently not enough charging stations around the world to provide charging for the increasing number of EV drivers and more EV vehicles. Because the infrastructure is unable to meet the demands, EV drivers must often queue/wait for hours at the charging stations. Additionally, charging can take up to 10 hours to recharge an EV battery from empty to full. So even after waiting extended periods of time to plug their EVs into a charging station, drivers must plan when they want to drive long distances to make sure that they have enough time and battery charge before arriving at their destinations or target charging stations.

Furthermore, while the number of public charging stations is increasing, there remain substantial gaps in coverage, particularly in rural and less densely populated areas. This disparity often leads to range anxiety among EV owners, who fear running out of power before reaching the next available charger. Additionally, the inconsistent availability of fast-charging stations exacerbates this issue, as slow chargers can significantly prolong travel times. The uneven distribution of chargers is a critical hurdle in the widespread adoption of electric vehicles, necessitating substantial investment and strategic planning to ensure a comprehensive and accessible charging network that can support the growing number of EVs on the road.

Existing technologies generally focus on planning to find the nearest charging station based on a remaining EV battery status. Existing technologies also provide a method where ECEUs may connect with a PEVC station in advance to assign an EV charger carrier to deliver a portable charger directly to the destination specified by the ECEU or where the PEVC station automatically estimates that the EV will soon run out of charge and then assigns a portable charging vehicle to go straight forward to the destination where the EV will run out of charge. However, the existing technologies are expensive and time-consuming.

According to aspects of this invention, there is a method of MPVC service with IT Data Analysis for automatically recharging an EV battery with enhanced optimal charging service features. In embodiments, the method and system disclosed herewith proactively provide a method to carry and share a portable EV charger in ride-sharing type of environment, to facilitate and benefit the target PEVC end users, PEVC service providers, and PEVC carriers.

Embodiments and aspects of the invention provide a system and method that improves and advances the technology in a specific and practical application. In other words, the systems and methods described herein overcome the foregoing problems by receiving EV data describing at least one connected electric vehicle and at least one PEVC unit; analyzing the received data to determine at least one PEVC demand requirement and at least one PEVC ride-sharing supply; assigning, by the processor set, an identified PEVC carrier to deliver a PEVC unit to a target PEVC end user; and transmitting, by the processor set, at least one delivery instruction to the assigned PEVC carrier and the target PEVC end user. Thus, improving the technological field of EV charging by creating more reliable and efficient systems and methods for providing an MPVC service by analyzing EV data, and scheduling, assigning, and managing PEVC unit deliveries to EVs needing a charge.

Indeed, the MPVC service described herein presents a promising solution to the above-described infrastructure gaps. These devices allow EV owners to charge their vehicles without needing to find a nearby fixed charging station, providing greater flexibility and peace of mind. PEVC units can be particularly useful in emergencies or in areas where fixed infrastructure is lacking. Additionally, aspects of this invention can serve as a stopgap solution while broader infrastructure improvements are being made, ensuring that EV drivers are not left stranded and can confidently travel longer distances without worrying about the availability of charging stations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the MPVC service code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

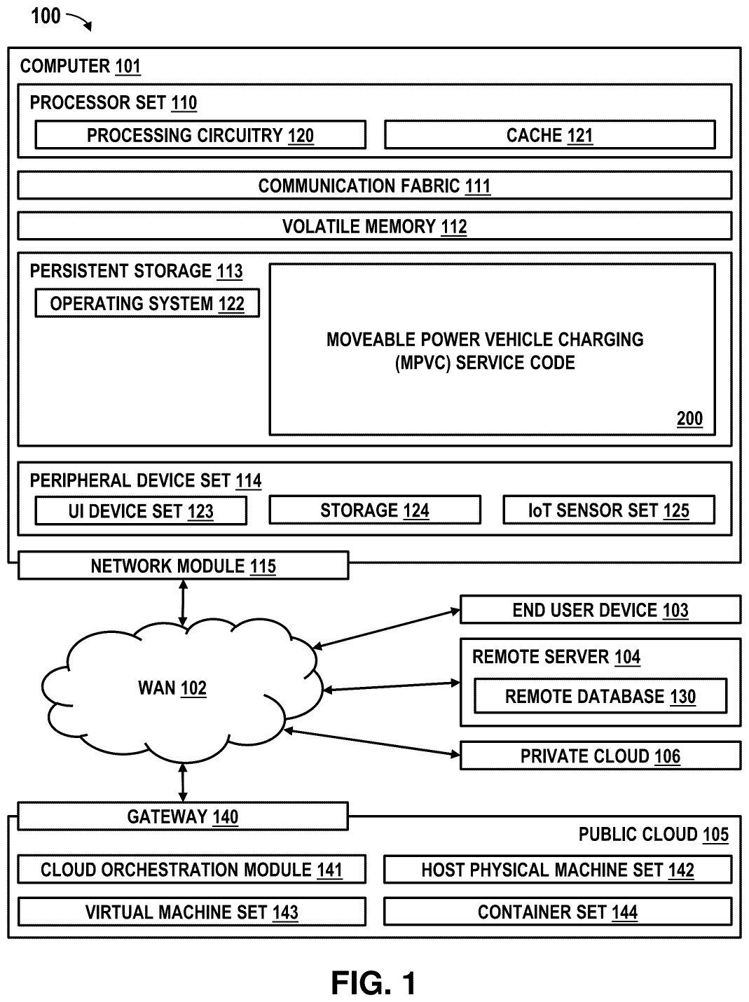

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

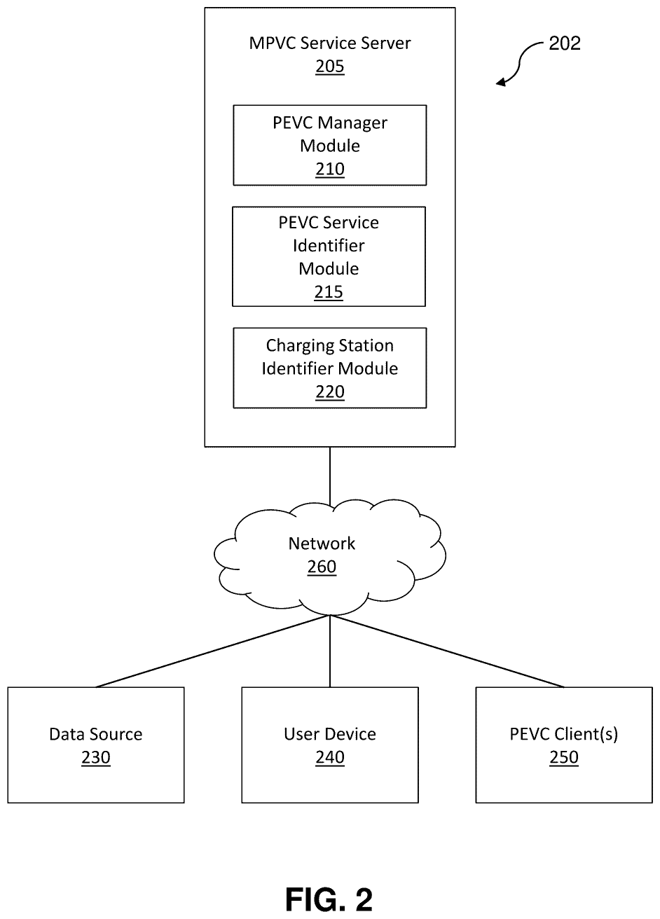

FIG. 2 shows a block diagram of exemplary environment 202 in accordance with aspects of the invention. In embodiments, environment 202 includes MPVC service server 205, data source 230, user device 240, PEVC client(s) 250, and network 260.

MPVC service server 205 may comprise one or more instances of computer 101 of FIG. 1. In another example, MPVC service server 205 may comprise one or more virtual machines or containers running on one or more instances of computer 101 of FIG. 1. In embodiments, MPVC service server 205 communicates with data source 230, user device 240, and/or PEVC client(s) 250 via network 260, which may comprise WAN 102 of FIG. 1 and/or may be implemented as a vehicle-to-everything (V2X) network. In embodiments, data source 230 comprises one or more data sources each comprising an instance of remote database 130 and/or remote server 104 of FIG. 1. In embodiments, user device 240 comprises one or more instances of end user device 103 of FIG. 1. There may be plural different instances of user device 240 including, for example, user-accessible servers, vehicular computing devices, and/or personal computing devices. The different instances of user device 240 may be used by different users and evaluators, respectively. In embodiments, PEVC client(s) 250 may comprise a device that belongs to or is controlled by an PEVC end user and/or a device that belongs to or is controlled by PEVC carrier.

In embodiments, MPVC service server 205 of FIG. 2 comprises PEVC manager module 210, PEVC service identifier module 215, and charging station identifier module 220, each of which may comprise modules of MPVC service code of block 200 of FIG. 1. Such modules may include routines, programs, objects, components, logic, data structures, and so on that perform a particular task (or tasks) or implement a particular data type (or types) that the MPVC service code of block 200 uses to carry out the functions and/or methodologies of embodiments of the invention as described herein. These modules of MPVC service code of block 200 are executable by computer 101 of FIG. 1 (e.g., processing circuitry 120 of FIG. 1) to perform the inventive methods as described herein. MPVC service server 205 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, MPVC service server 205 is configured to receive, access, and/or monitor electric vehicle (EV) data describing a plurality of connected electric vehicles and/or PEVC units. As used herein, EV data may include service profiles, user profiles, PEVC criteria, PEVC data structure information, charging service analysis data, availability data, service collection data, waiting time data, power prediction data, PEVC service request data, charging station data, power ability data, ride-sharing data, and more.

In accordance with aspects of the invention, PEVC manager module 210 is configured to analyze received/collected EV data to determine at least a charging demand requirement and a ride-sharing supply. In embodiments, PEVC manager module 210 makes this identification using the received EV data.

In embodiments, PEVC manager module 210 may be further configured to send the determined charging demand requirement and the ride-sharing supply to the identified target PEVC end user and the at least one potential PEVC carriers. In other words, after PEVC manager module 210 has identified the target PEVC end user and the potential PEVC carrier, it may optionally send details of the determination to one, or both, of the target PEVC end user and/or the potential PEVC carrier. In embodiments, PEVC manager module 210 may optionally match the identified target PEVC end user and one or more potential PEVC carriers.

In embodiments, PEVC manager module 210 is configured to assign a matched PEVC carrier to deliver a PEVC unit to the target PEVC end user. In other words, PEVC manager module 210 assigns the task of delivering a PEVC unit to the target end user to a matched PEVC carrier. In embodiments, PEVC manager module 210 may be further configured to generate and transmit the assignment and instructions to the matched PEVC and to the target PEVC end user. In embodiments, the assignment and instructions may comprise information describing the target PEVC end user and/or the PEVC carrier, information describing a time and location for exchanging the PEVC unit, contact information for the PEVC end user and/or the PEVC carrier such that the end user and carrier may correspond to make additional arrangements, and/or any other information that may be helpful to arrange the PEVC unit exchange.

In accordance with aspects of the invention, PEVC service identifier module 215 is configured to receive confirmation from the assigned PEVC carrier that the PEVC unit has been delivered to the target PEVC end user. That is, after the PEVC carrier has delivered and/or exchanged the PEVC unit to the target PEVC end user, the PEVC carrier and/or the target PEVC end user are configured to notify PEVC service identifier module 215 that the exchange/delivery has occurred.

In embodiments, PEVC service identifier module 215 may be further configured to detect when the PEVC unit has been returned without receiving a confirmation message. Based on the received/accessed/monitored data above, PEVC service identifier module 215 may detect/determine that the PEVC unit has been returned to the PEVC service provider. In embodiments, PEVC service identifier module 215 may further comprise a data collector, user profile, power predictor, PEVC service requester, charging station service requester, PEVC service receiver, and more.

In accordance with aspects of the invention, charging station identifier module 220 is configured to collect, obtain, and/or monitor data related to the carrier's EV, including, current charge level, speed, current power requirements, predicted future power requirements, and more. In embodiments, charging station identifier module 220 may further comprise a data collector, user profile, power ability predictor, power predictor, ride-sharing PEVC service receiver, and ride-sharing PEVC service requester, and more. In embodiments, the ride-sharing PEVC service receiver is a module/dashboard at the EV that acts as an interface for receiving a PEVC unit/service request and the ride-sharing PEVC service requester is a module/dashboard at the EV that acts as an interface for requesting a PEVC unit/service on behalf of the charging station identifier module 220.

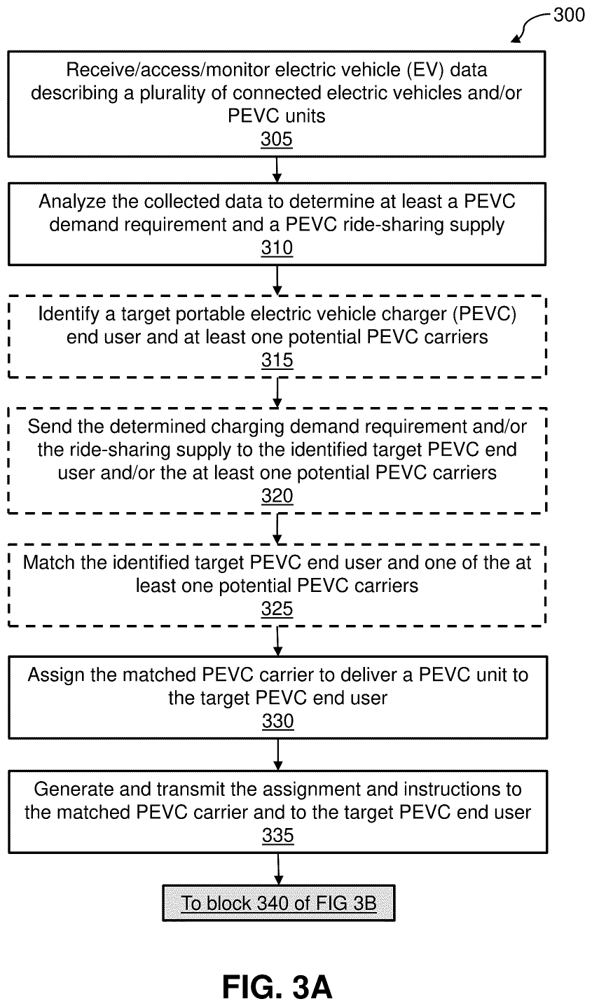

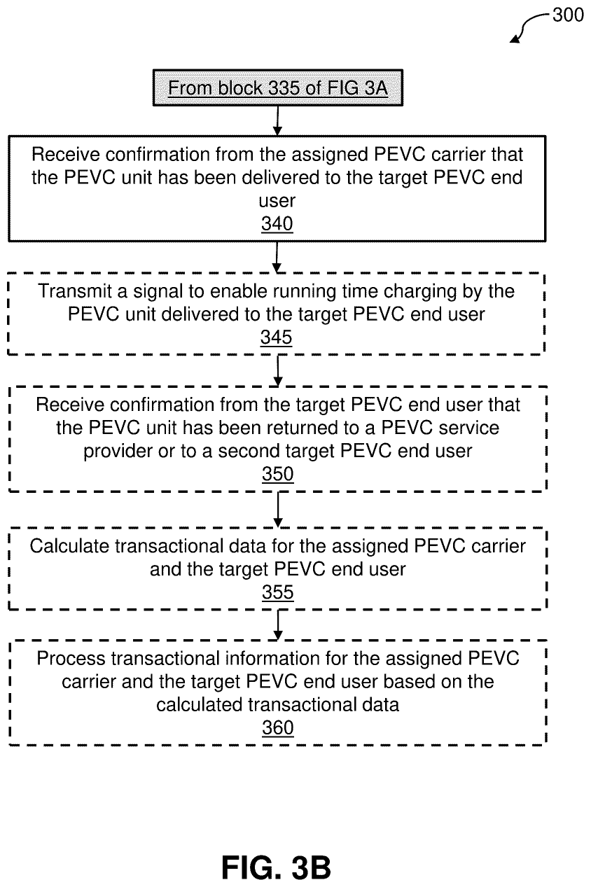

FIGS. 3A-B show a flowchart of exemplary method 300 in accordance with aspects of the present invention. Steps of the method may be carried out in the environment of FIG. 2 and are described with reference to elements depicted in FIG. 2.

At block 305 of FIG. 3A, MPVC service server 205 is configured to receive, access, and/or monitor electric vehicle (EV) data describing a plurality of connected electric vehicles and/or PEVC units. As used herein, EV data may include service profiles, user profiles, PEVC criteria, PEVC data structure information, charging service analysis data, availability data, service collection data, waiting time data, power prediction data, PEVC service request data, charging station data, power ability data, ride-sharing data, and more. Furthermore, connected electronic vehicles and/or PEVC units, as used herein describes any EV or PEVC unit that is in electronic communication with (i.e., is configured to send and/or receive messages to/from) MPVC service server 205 via network 260. In embodiments, the data is collected at the EV and/or PEVC units by sensors, including internet-of-things (IoT) sensors.

In embodiments, MPVC service server 205 receives, accesses, and/or monitors the EV data from the sensors directly. In other embodiments the EV data is received from the EVs and/or PEVC units. In embodiments, the received, accessed, and/or monitored data may be converted and/or normalized in accordance with a data structure used by PEVC service identifier module 215. In other words, the data may be manipulated or converted to match the data structure used by the MPVC service system.

At block 310, PEVC manager module 210 is configured to analyze the collected data to determine at least a charging demand requirement and a ride-sharing supply. As described above with respect to block 305, the collected data may include service profiles, user profiles, PEVC criteria, PEVC data structure information, charging service analysis data, availability data, service collection data, waiting time data, power prediction data, PEVC service request data, charging station data, power ability data, ride-sharing data, and more. Thus, in embodiments, PEVC manager module 210 analyzes the received data to determine a charging demand requirement(s) (e.g., an end user that is in need of a PEVC unit) and/or a ride-sharing supply (e.g., a service provider's supply of PEVC units and/or PEVC carrier's ability to deliver a PEVC unit).

At block 315, PEVC manager module 210 may optionally (as indicated by a dotted line in the figure) identify a target PEVC end user and at least one potential PEVC carrier. In embodiments, PEVC manager module 210 makes this identification using the data received at block 305. In additional embodiments, PEVC manager module 210 makes the identification using the charging demand requirement(s) and/or the ride-sharing supply determined at block 310. In an exemplary embodiment, based on a determination that a first PEVC end user's EV is running low on a charge and that the first PEVC end user does not have enough power to make it to the next EV service station along its travel route, PEVC manager module 210 may identify the first PEVC end user as a target PEVC end user. In another exemplary embodiment, based on a determination that a first PEVC carrier is available to deliver a PEVC unit, is located near a location to pick up an available PEVC unit, and the first PEVC carrier's EV has enough charge to deliver the PEVC unit to a PEVC end user, PEVC manager module 210 may identify the first PEVC carrier as a potential PEVC carrier. In embodiments, more than one potential PEVC carrier may be identified. In other embodiments other/additional data may be used to identify the target PEVC end user and the potential PEVC carrier.

At block 320, PEVC manager module 210 may optionally send the determined charging demand requirement and/or the ride-sharing supply to the identified target PEVC end user and/or the at least one potential PEVC carrier. In other words, after PEVC manager module 210 has identified the target PEVC end user and the potential PEVC carrier, it may optionally send details of the determination to one, or both, of the target PEVC end user and/or the potential PEVC carrier. For example, PEVC manager module 210 notify the target PEVC end user that its EV is running low on a charge, that the target PEVC end user does not have enough power to make it to the next EV service station along its travel route, and/or that a first PEVC carrier is available to deliver a PEVC unit. In another exemplary embodiment, PEVC manager module 210 notify the potential PEVC carrier that its EV is running low on a charge, that the target PEVC end user does not have enough power to make it to the next EV service station along its travel route, that the potential PEVC carrier is located near a location to pick up an available PEVC unit, that the potential PEVC carrier's EV has enough charge to deliver the PEVC unit to a PEVC end user. In embodiments, data may be shared with more than one potential PEVC carrier. In other embodiments other/additional data may be sent, shared, and/or transmitted.

At block 325, PEVC manager module 210 may optionally match the identified target PEVC end user and one or more potential PEVC carriers. In embodiments, matching may comprise sharing additional data with each of the matched parties in accordance with block 320, including notifying each party that they have been matched. In additional embodiments, matching may additionally, or alternatively, include allowing one or both users to accept the matching. For example, in an embodiment, one or more potential PEVC carriers may accept or decline the matching upon receiving the data. In embodiments where either the target PEVC end user or one or more potential PEVC carriers declined the match, then no further action would be taken because the match would be declined and/or removed.

At block 330, PEVC manager module 210 is configured to assign a matched PEVC carrier to deliver a PEVC unit to the target PEVC end user. In other words, PEVC manager module 210 assigns the task of delivering a PEVC unit to the target end user to a matched PEVC carrier. In embodiments, the matched PEVC carrier is matched in accordance with block 325, where the user is provided an option to accept or decline the matching. In other embodiments, the system assigns the task based on a potential PEVC carrier's preconfigured status. For example, a potential PEVC carrier may indicate that when certain conditions are met, they would like to be assigned the task of delivering a PEVC unit to the target end user. In an exemplary embodiment, a preconfigured status may include information, or an algorithm, which dictates when a potential PEVC carrier may automatically be assigned. In such embodiments, data such as if the potential PEVC carrier is located near a location to pick up an available PEVC unit, if the potential PEVC carrier's EV has enough charge to deliver the PEVC unit to a PEVC end user, and/or if the payment for delivering the PEVC unit exceeds a predetermined threshold amount, then the user may opt-in to being automatically assigned the delivery task. In other embodiments other/additional data may be selected by the potential PEVC carriers to determine whether to automatically assign a delivery task to the respective PEVC carriers.

In embodiments, the target PEVC end user is matched as described with respect to block 325, where the user is provided an option to accept or decline the matching. In other embodiments, the system assigns the task based on the target PEVC end user's preconfigured status. For example, the target PEVC end user may indicate that when certain conditions are met, they would like any available and/or willing potential PEVC carrier to be assigned the task of delivering the PEVC unit. In an exemplary embodiment, a preconfigured status may include information, or an algorithm, which dictates when the target PEVC end user may automatically be assigned. In such embodiments, data such as if the potential PEVC carrier can deliver the PEVC unit to located along the target PEVC end user's travel path, if a return location for the PEVC unit is along the target PEVC end user's travel path, if the PEVC unit is configure to allow for mobile charging (i.e., charging while the EV is traveling), and/or if the payment for delivering the PEVC unit is less than a predetermined threshold amount, then the user may opt-in to being automatically assigned a PEVC carrier. In other embodiments other/additional data may be selected by the target PEVC end user to determine whether to automatically assign a delivery task to a potential PEVC carrier.

At block 335, PEVC manager module 210 is configured to generate and transmit the assignment and instructions to the matched PEVC carrier and to the target PEVC end user. In embodiments, as explained above, the assignment and instructions may comprise information describing the target PEVC end user and/or the PEVC carrier, information describing a time and location for exchanging the PEVC unit, contact information for the PEVC end user and/or the PEVC carrier such that the end user and carrier may correspond to make additional arrangements, and/or any other information that may be helpful to arrange the PEVC unit exchange.

At block 340 of FIG. 3B, PEVC service identifier module 215 is configured to receive confirmation from the assigned PEVC carrier that the PEVC unit has been delivered to the target PEVC end user. That is, after the PEVC carrier has delivered and/or exchanged the PEVC unit to the target PEVC end user, the PEVC carrier and/or the target PEVC end user are configured to notify PEVC service identifier module 215 that the exchange/delivery has occurred. In embodiments, the confirmation message sent from the PEVC carrier and/or the target PEVC end user (e.g., PEVC client(s) 250) over/through/via network 260.

At block 345, PEVC manager module 210 may optionally transmit a signal to enable running time charging by the PEVC unit delivered to the target PEVC end user. In other words, PEVC manager module 210 may transmit a signal that allows a PEVC unit to provide a charge to the EV while the EV is in motion. In other embodiments, running time charging may be enabled without a signal from PEVC manager module 210. In other embodiments, running time charging may be a default setting for PEVC units and/or EV that are configured to allow running time charging.

At block 350, PEVC service identifier module 215 may optionally receive confirmation from the target PEVC end user that the PEVC unit has been returned to the PEVC service provider or to another target end user. In other words, when the PEVC unit is either returned to the PEVC service provider or to another (e.g., a second target PEVC end user) the PEVC service provider, the first target PEVC end user, and/or the second target PEVC end user may be configured to notify PEVC service identifier module 215 that the exchange/delivery/return has occurred. In embodiments, the confirmation message sent from the PEVC service provider, the first target PEVC end user, and/or the second target PEVC end user (e.g., PEVC client(s) 250) may occur over/through/via network 260. In embodiments the confirmation message is automatically sent from one or more of the devices without requiring user input.

In embodiments, PEVC service identifier module 215 is configured to detect when the PEVC unit has been returned without receiving a confirmation message. In such embodiments, PEVC manager module 210 may receive, access, and/or monitor EV data describing one or more of the target PEVC end users, PEVC carrier, and PEVC unit. Based on the received/accessed/monitored data, PEVC manager module 210 and PEVC service identifier module 215 may detect/determine that the PEVC unit has been returned to the PEVC service provider. Data used to make this determination may include data such as Global Positioning System (GPS) data of each EV/unit in relation to the other EVs/units, amount of charge remaining in the PEVC unit, charging status of the target PEVC end user, charging status of the PEVC unit, and more. For example, if the GPS coordinates describing the location of the target PEVC end user and the PEVC unit approach a PEVC service provider while the target PEVC end user's EV is charging and while the PEVC unit is dispensing a charge, but a few minutes later, the GPS coordinates describe location of the target PEVC end user as moving and the GPS coordinates describe location of the PEVC unit as being stationary at the PEVC service provider while the target PEVC end user's EV is not charging and while the PEVC unit is accepting a recharge, PEVC service identifier module 215 may determine that the PEVC unit has been returned.

At block 355, PEVC manager module 210 is optionally configured to calculate transactional data for the assigned PEVC carrier and the target PEVC end user. In embodiments the transactional data is calculated based on received, accessed, and/or monitored EV data describing the plurality of connected EVs and/or PEVC units. In other words, using the EV data, PEVC manager module 210 can determine a cost for the charge and service rendered to the target PEVC end user, a cost to dispense/pay to the PEVC carrier, and/or a cost to dispense/pay to the PEVC service provider. In embodiments, the cost may be a monetary value. In other embodiments, the cost may be a number of credits or units within the MPVC service system. In such embodiments, the credits or units may be used to trade goods or services within the MPVC service system.

At block 360, PEVC manager module 210 may optionally process transactional information for the assigned PEVC carrier and the target PEVC end user based on the calculated transactional data. In other words, after the transactional data is calculated in accordance with block 355, PEVC manager module 210 processes the transactional data and distributes and/or collects the cost/value for the goods and services rendered and/or received.

In embodiments, PEVC manager module 210 may employ a machine learning model to analyze perform one or more the aspects described with respect to blocks 305, 310, 315, 325, and 330 of FIG. 3A. For example, in such embodiments, PEVC manager module 210 may use machine learning algorithms such as a user-based collaborative filtering algorithm, a greedy algorithm, a shortest path search algorithm, a nearest neighbor search algorithm, an optimal matching algorithm, or any other suitable algorithm to perform the forgoing aspects.

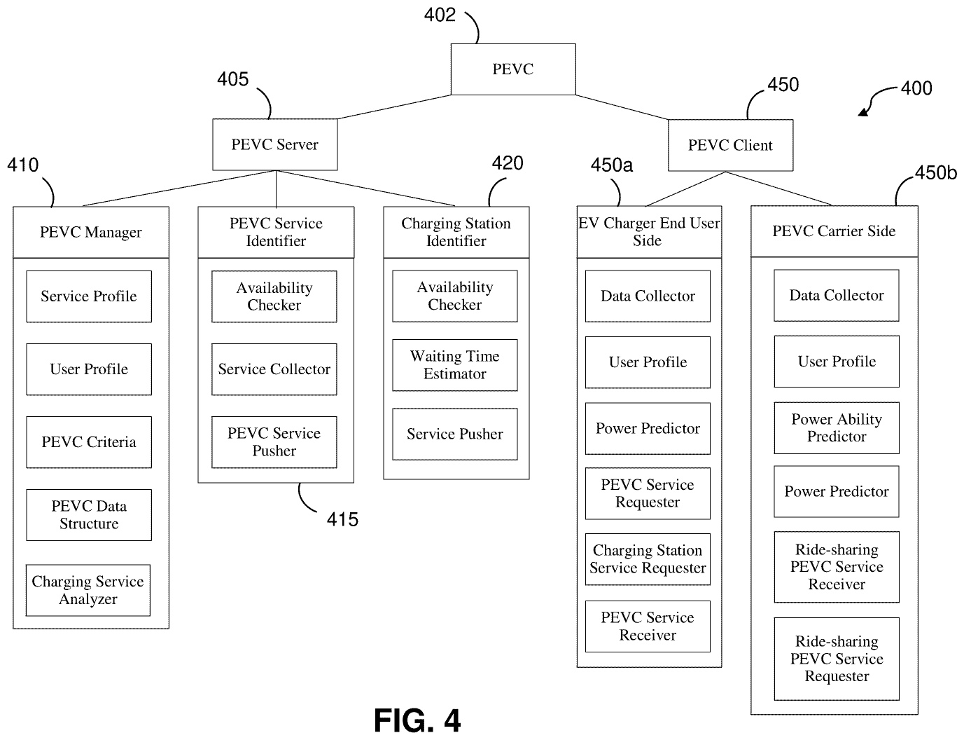

FIG. 4 shows a block diagram of an exemplary environment 400 in accordance with aspects of the present invention. At least portions of environment 400 may be described with reference to some elements depicted in FIG. 2. In embodiments, environment 400 includes PEVC Server 405, which may comprise one or more instances of MPVC service server 205, and PEVC clients 450a-b, which may comprise one or more instances of PEVC client(s) 250.

In embodiments, PEVC Server 405 includes and/or is in communication with PEVC Manager 410, which may comprise one or more instances of PEVC manager module 210; PEVC service identifier 415, which may comprise one or more instances of PEVC service identifier module 215; and charging station identifier, which may comprise one or more instances of station identifier module 220.

In embodiments, PEVC Manager 410 may comprise and/or maintain a service profile(s), user profile(s), PEVC criteria, PEVC data structure(s), charging service analyzer, and more. In embodiments, a service profile may be configured to store and/or maintain service information such as, for example, a current location of a PEVC carrier, charger pick-up location of a PEVC carrier, target location of a PEVC carrier, PEVC unit charge status, PEVC service status, PEVC charging fee discount(s), road time and estimated waiting time at nearest charging station, and more.

In embodiments, a user profile contains information about the users of the system whether they be a target PEVC end user, PEVC carrier, or a PEVC service provider. In embodiments the information about the users may include driving styles (e.g., aggressive, conservative, etc.), driving habits (e.g., time of day, speed, relative speed, etc.), typical routes chosen by the user (e.g., scenic, toll, toll-free, fastest possible, and/or other types of routes), and/or any other information that may describe a user.

In embodiments, PEVC criteria includes one or more thresholds that must/should be met to trigger a PEVC service request. For example, PEVC criteria may include an EV charge, a next available service station, a wait time at service stations along the EV's travel path, availability for a PEVC unit delivery, amount of charge in the available PEVC units, and other criteria that may be measured to determine whether/when to trigger a PEVC service request.

In embodiments, the PEVC data structure may define, use, and maintain a specific data structure to operate within the MPVC service system. In embodiments, the data structure tracks, saves, processes, normalizes, and maintains PEVC related data. In embodiments, the PEVC data can be PEVC end user data, travel option data (e.g., fastest, cheapest, scenic, etc.), PEVC service provider data, ride-sharing mode/data (i.e., willingness to carry a PEVC unit), target point data (i.e., for end users and carriers), charger return point data, PEVC carrier data, current PEVC carrier location data, PEVC unit picking point, PEVC service status, PEVC charging fees, road time data, estimated waiting time at charging stations, and more. In embodiments, the PEVC data structure tracks, saves, processes, normalizes, and maintains this information for entire fleets of EV that are connected to the MPVC service system.

In embodiments, a charging service analyzer maintains an algorithm for determining which charging options best satisfies the EV user's intention. For example, in embodiments the steps of the algorithm are described with respect to blocks 305-335 of FIG. 3A. In embodiments, the system may review the wait times for charging stations along the EV's travel path and determine that a PEVC unit is not necessary as the EV user may obtain a faster (or cheaper) charge at a service station. In embodiments where the EV user wants the cheapest charge, the algorithm may be adjusted by assigning weights to options that provide a cheaper charge. Similarly, in embodiments where the EV user wants the fastest charge, the algorithm may be adjusted by assigning weights to options that provide a fast charge. In this manner, the charging service analyzer will determine the best/optimal options for meeting the EV user's predetermined/prespecified needs.

In embodiments, the charging service analyzer receives information from PEVC service identifier 415 (e.g., via its PEVC service pusher) and charging station identifier 420 (e.g., via its service pusher) to make the foregoing determinations. For example, in embodiments, PEVC service identifier 415 uses its availability checker and service collector to keep record of the status of each PEVC unit under its control. In this manner, PEVC service identifier 415 knows the real time status, and availability, of each PEVC unit and/or potential PEVC carriers and pushes that information (or otherwise makes that information available) to PEVC Manager 410. Similarly, in embodiments, charging station identifier 420 uses its availability checker and waiting time estimator to keep record of the status of each charging station under its control. In this manner, charging station identifier 420 knows the real time status, estimated waiting time, and/or availability, of each PEVC unit and pushes that information (or otherwise makes that information available) to PEVC Manager 410. In embodiments PEVC Manager 410 may pull, obtain, and/or request the data from PEVC service identifier 415 and/or charging station identifier 420.

In embodiments, PEVC client 450 includes and/or is in communication with EV charger end user side 450a, which may comprise one or more instances of the target PEVC end user described above. In embodiments, EV charger end user side 450a may comprise a data collector, user profile, power predictor, PEVC service requester, charging station service requester, PEVC service receiver, and more. In embodiments each of the foregoing EV charger end user side 450a features are in communication with a sensor configured to send/receive data.

In embodiments, the EV charger end user side 450a data collector may collect, obtain, and/or monitor data related to the end user's EV, including, current charge level, speed, current power requirements, predicted future power requirements, and more. In embodiments, the EV charger end user side 450a user profile may store information related to the EV user's driving styles (e.g., aggressive, conservative, etc.), driving habits (e.g., time of day, speed, relative speed, etc.), typical routes chosen by the user (e.g., scenic, toll, toll-free, fastest possible, and/or other types of routes), and/or any other information that may describe a user.

In embodiments, the EV charger end user side 450a power predictor may analyze and/or monitor the EV's current usage, power requirements, expected future power requirements based on the user's driving habits, future terrain on the travel route, time of day, temperature, and/or any other information that may be used to predict an amount of power needed to complete a travel route in an EV.

In embodiments, the EV charger end user side 450a PEVC service requester is a module/dashboard at the EV that acts as an interface for requesting a PEVC unit/service. In embodiments, the system may be configured to automatically request a PEVC unit/service when predetermined criteria are met (e.g., when an EV has less than 50 km of charge and when the next charge station is more than 50 km away). In other embodiments, the system may send a notification to the EV charger end user via the PEVC service requester that indicates that requesting a PEVC unit/service is the best option for meeting the user's needs. In embodiments, the end user may interact with the PEVC service requester to manually request a PEVC unit/service.

In embodiments, the EV charger end user side 450a charging station service requester is a module/dashboard at the EV that acts as an interface for requesting/reserving a charge at a charge/service station. In embodiments, the system may be configured to automatically request/reserve a charge at a service station when predetermined criteria are met (e.g., when the estimated waiting time is less than 20 minutes). In other embodiments, the system may send a notification to the EV charger end user via the charging station service requester that indicates that requesting/reserving a charge at a service station is the best option for meeting the user's needs. In embodiments, the end user may interact with the charging station service requester to manually request/reserve a charge at a charging station.

In embodiments, PEVC client 450 includes and/or is in communication with PEVC carrier side 450b, which may comprise one or more instances of the potential PEVC carrier described above. In embodiments, PEVC carrier side 450b may comprise a data collector, user profile, power ability predictor, power predictor, ride-sharing PEVC service receiver, and ride-sharing PEVC service requester, and more. In embodiments each of the foregoing PEVC carrier side 450b features are in communication with a sensor configured to send/receive data.

In embodiments, PEVC carrier side 450b data collector may collect, obtain, and/or monitor data related to the carrier's EV, including, current charge level, speed, current power requirements, predicted future power requirements, and more. In embodiments, the PEVC carrier side 450b user profile may store information related to the EV carrier's driving styles (e.g., aggressive, conservative, etc.), driving habits (e.g., time of day, speed, relative speed, etc.), typical routes chosen by the user (e.g., scenic, toll, toll-free, fastest possible, and/or other types of routes), and/or any other information that may describe a user.

In embodiments, the PEVC carrier side 450b power ability predictor may store information related to the carrier's ability to carry a PEVC unit. For example, if an EV can carry up to three PEVC units at any given time, the power ability predictor would analyze, track, and/or monitor the EV's real time capacity capabilities. In embodiments, the power ability predictor may also track/monitor the amount of charge on a PEVC unit already onboard with the PEVC carrier. For example, the power ability predictor would know that a given PEVC carrier is carrying two PEVC units, one of the units has a 50% charge while the other has a 31% charge.

In embodiments, the PEVC carrier side 450b power predictor may analyze and/or monitor the EV's current usage, power requirements, expected future power requirements based on the user's driving habits, future terrain on the travel route, time of day, temperature, and/or any other information that may be used to predict an amount of power needed to complete a travel route in an EV.

In embodiments, the PEVC carrier side 450b ride-sharing PEVC service receiver is a module/dashboard at the EV that acts as an interface for receiving a PEVC unit/service request. In embodiments, the system may be configured to automatically receive a PEVC unit/service request. In other embodiments, the system may send a notification to the PEVC carrier via the ride-sharing PEVC service receiver. In embodiments, the ride-sharing PEVC service receiver further includes an interface for the user to accept/decline a PEVC unit/service request.

In embodiments, the PEVC carrier side 450b ride-sharing PEVC service requester is a module/dashboard at the EV that acts as an interface for requesting a PEVC unit/service. In embodiments, the system may be configured to automatically request a PEVC unit/service when predetermined criteria are met (e.g., when an EV has less than 50 km of charge and when the next charge station is more than 50 km away). In other embodiments, the system may send a notification to the EV charger end user via the PEVC ride-sharing service requester that indicates that requesting a PEVC unit/service is the best option for meeting the user's needs. In embodiments, the carrier may interact with the PEVC service requester to manually request a PEVC unit/service.

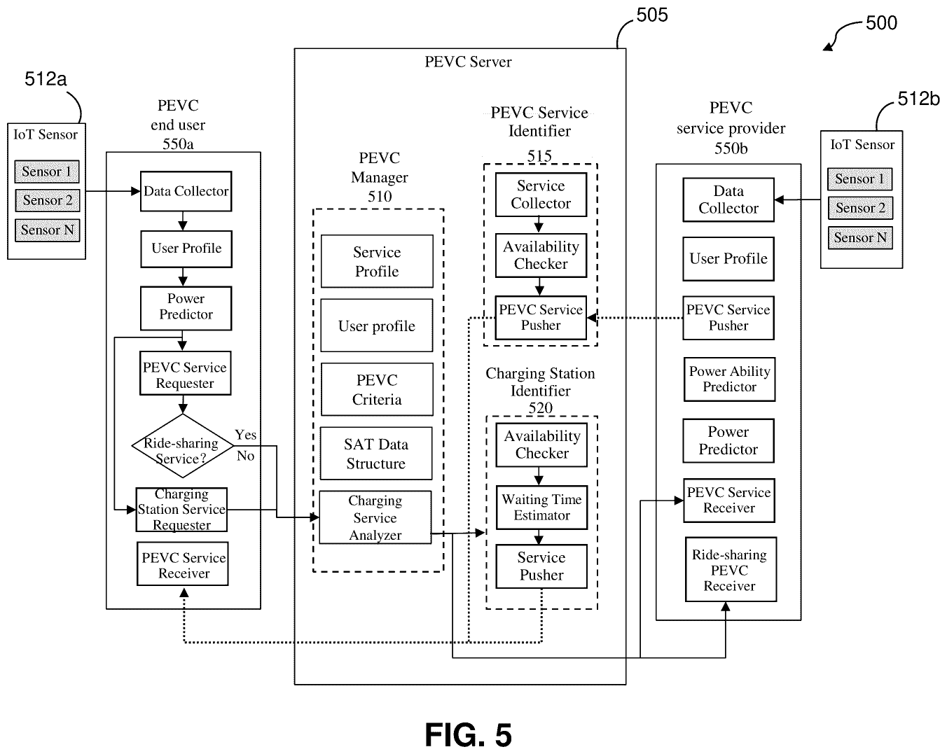

FIG. 5 shows a block diagram of an exemplary environment 500 in accordance with aspects of the present invention. As illustrated, environment 500 illustrates the interaction between IoT sensors 512a-b, PEVC end users 550a, PEVC server 505 (which comprises PEVC manager 510, PEVC service identifier 515, and charging station identifier 520), and the PEVC service provider 550b in accordance with the environments and methods described with respect to FIGS. 2-4. For example, as illustrated IoT sensors 512a collect, gather, and send PEVC related data to PEVC end user 550a and PEVC service provider 550b. In embodiments PEVC end user 550a and PEVC service provider 550b may each comprise instances of one or more PEVC client(s) 250 of FIG. 2.

In embodiments, upon receiving data from IoT sensors 512a-b, PEVC end user 550a and PEVC service provider 550b may track, save, process, normalize, and/or maintain PEVC related data obtained from IoT sensors 512a-b and/or from other external sources. In embodiments the PEVC related data is tracked, saved, processed, normalized, and/or maintained in accordance with the environments and methods described with respect to FIGS. 2-4.

In embodiments, when PEVC end user 550a needs a ride-sharing service (e.g., in need of a PEVC unit), it sends a request to the charging service analyzer of PEVC manager 510. In embodiments, PEVC manager 510 may analyze the data to determine a charging demand requirement (e.g., a ride-sharing service need), in accordance with blocks 305-310 of FIG. 3A, without receiving a request from PEVC end user 550a. Upon receiving/detecting a ride-sharing service need, PEVC manager 510 may send the request to the ride-sharing PEVC receiver and/or the PEVC service receiver at PEVC service provider 550b in accordance with blocks 315-335 of FIG. 3A. In response to data being shared/passed/received between PEVC end user 550a, PEVC service provider 550b, and PEVC server 505, PEVC server 505 coordinates the MPVC service in accordance with the environments and methods described with respect to FIGS. 2-4.

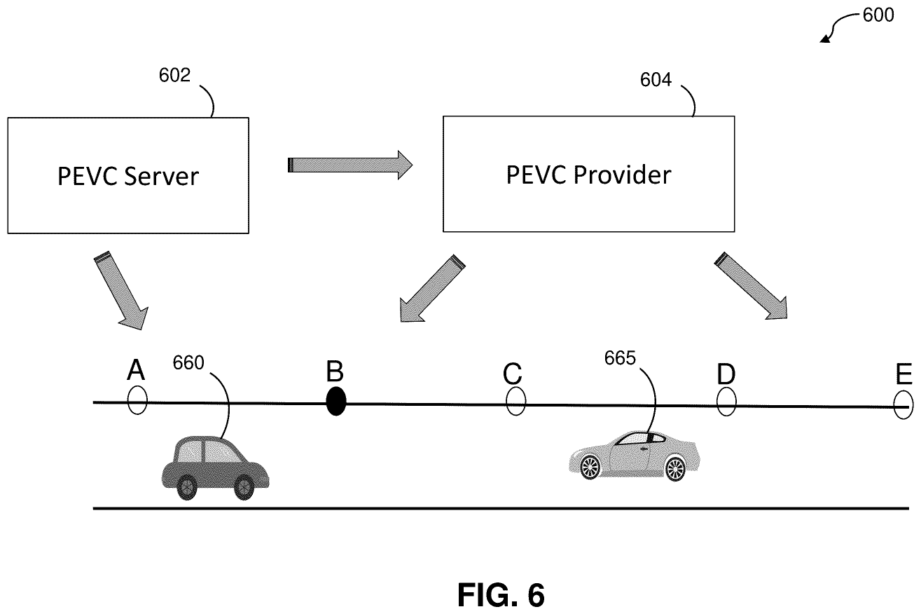

FIG. 6 shows a diagram of an exemplary environment 600 in accordance with aspects of the present invention. As illustrated, PEVC provider 604 (a PEVC service provider) maintains service locations at A, C, D, and E (illustrated with a hollow circle) along a street, route, highway, and/or any path of travel. As depicted, EV 660 travels along the route that spans from location A to location E and is currently located between service location A and point B, however EV 660 does not have enough charge to make it to service location C. EV 665 travels on the route that spans from location A to location E, in the opposite direction of EV 660. EV 665 is currently located between service locations C and D. As depicted, EV 660 may send a request for a PEVC unit from PEVC provider 604. In embodiments EV 660's request for a PEVC unit may be sent to PEVC provider 604 over a wireless network and/or to other EV's using a vehicle-to-vehicle (V2V) network. One or both of PEVC server 602 and PEVC provider 604 may detect that EV 665 is the best candidate to deliver a PEVC unit to EV 660, in accordance with blocks 315-325 of FIG. 3A. In this manner, EV 665 may be assigned to deliver the PEVC unit by picking the unit up at location C and meeting EV 660 at point B to deliver the PEVC unit, in accordance with blocks 330 and 335 of FIG. 3A.

In embodiments, PEVC provider 604 may issue the delivery assignment to EV 665 with a token. In such embodiments, the issued token is used to collect the PEVC unit at service location C. In embodiments, EV 665 may be allowed/enabled to send a message to EV 660 indicating an estimated time of arrival at point B. When at point B, EV 665 may pass the rented PEVC unit to EV 660. In embodiments, the operator of EV 660 may transmit a payment to PEVC provider 604 and/or EV 665 for the PEVC unit rental and/or service rendered in accordance with blocks 355 and 360 of FIG. 3B. In embodiments, EV 660 may return the PEVC unit to one of PEVC provider 604's service locations (i.e., locations C, D, or E), in accordance with block 350 of FIG. 3B.

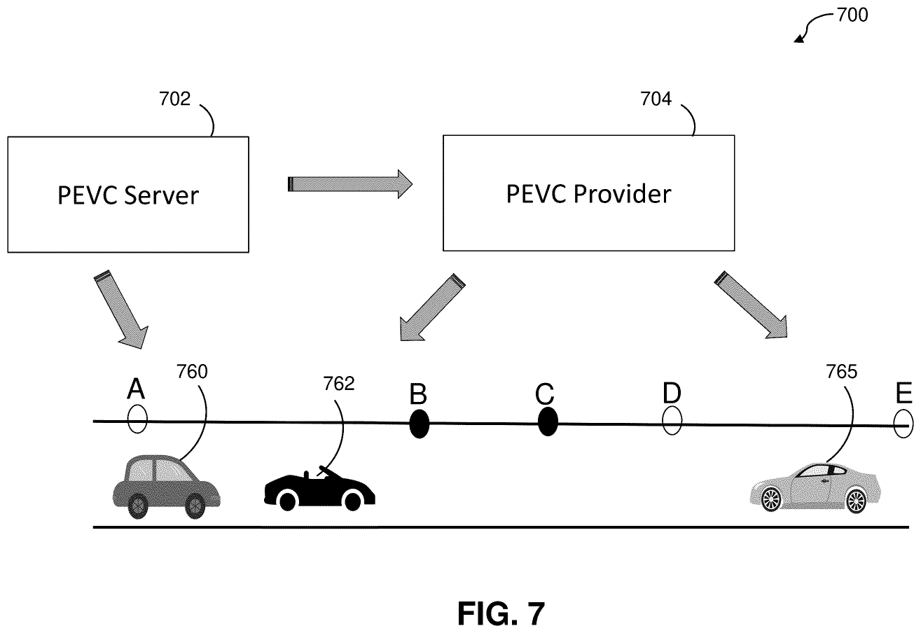

FIG. 7 shows a diagram of an exemplary environment 700 in accordance with aspects of the present invention. As illustrated, PEVC provider 704 maintains service locations at A, D, and E (illustrated with a hollow circle) along a street, route, highway, and/or any path of travel. As depicted, EV 760 travels along the route that spans from location A to location E and is currently located between service location A and point B. Further depicted, EV 762 travels along the route that spans from location A to location E and is also currently located between service location A and point B. Neither EV 760 nor EV 762 has enough charge to make it to service location D. EV 765 travels along the route that spans from location A to location E, in the opposite direction of EV 760 and EV 762. EV 765 is currently located between service locations D and E. As depicted, EV 760 and EV 762 may each send a request for a PEVC unit from PEVC provider 704 over a wireless network and/or to other EV's using a V2V network. One or both of PEVC server 702 and PEVC provider 704 may detect that EV 765 is the best candidate to deliver a PEVC unit to both EV 760 and EV 762, in accordance with blocks 315-325 of FIG. 3A. In this manner, EV 765 may be assigned to deliver the PEVC unit by picking the unit up at location D and meeting EV 762 at point C and EV 760 at point B to deliver the respective PEVC units, in accordance with blocks 330 and 335 of FIG. 3A.

In embodiments, PEVC provider 704 may issue the delivery assignment to EV 765 with a token. In such embodiments, the issued token is used to collect the PEVC units at service location D. In embodiments, EV 765 may be allowed/enabled to send messages to EV 760 and EV 762 indicating an estimated time of arrival at points C and B. When at the respective points, EV 765 may pass the rented PEVC units to EV 762 and EV 760, respectively. In embodiments, the operators of EV 760 and EV 762 may transmit a payment to PEVC provider 704 and/or EV 765 for the PEVC unit rentals and/or services rendered in accordance with blocks 355 and 360 of FIG. 3B. In embodiments, EV 760 and EV 762 may return the PEVC units to one of PEVC provider 704's service locations (i.e., locations D or E), in accordance with block 350 of FIG. 3B.

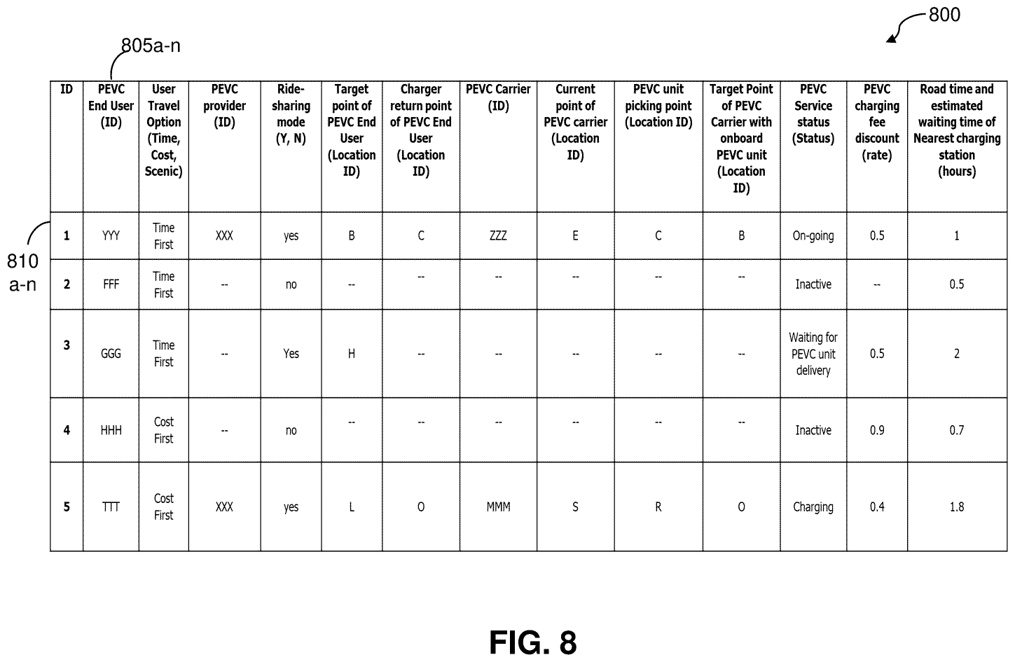

FIG. 8 shows a table of exemplary data structure 800 in accordance with aspects of the present invention. As provided above with respect to FIG. 5, a PEVC data structure may define, use, and maintain a specific data structure to operate within the MPVC service system. In embodiments, the data structure tracks, saves, processes, normalizes, and maintains PEVC related data. As illustrated in FIG. 8, data structure 800 may comprise a plurality of columns 805a-n and a plurality of rows 810a-n. Each column contains a specific type of tracked, saved, processed, normalized, and/or maintained data. Similarly, each row contains tracked, saved, processed, normalized, and/or maintained data that describes a unique user.

In embodiments, columns 805a-n may include PEVC end user ID, user travel options (e.g., fastest, cheapest, scenic, etc.), PEVC service provider ID, ride-sharing mode (i.e., willingness to carry a PEVC unit), target point of PEVC end user, charger return point of PEVC end user, PEVC carrier ID, current point of PEVC carrier, PEVC unit picking point, target of PEVC carrier with onboard PEVC unit, PEVC service status (e.g., on-going, inactive, waiting, charging, etc.), PEVC charging fee discount (e.g., a percentage or decimal), and road time and estimated waiting time of nearest charging station. Thus, in embodiments, using the methods described with respect to FIGS. 3A-7, the PEVC data structure tracks, saves, processes, normalizes, and maintains this information for entire fleets of EV that are connected to the MPVC service system to recommend and/or schedule a MPVC service that best meets an individual driver's needs based on the resources and services available to them.

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, aspects of the invention provide a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system may include one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, electric vehicle (EV) data describing at least one connected electric vehicle and at least one portable electric vehicle charging (PEVC) unit;
analyzing, by the processor set, the received data to determine at least one PEVC demand requirement and at least one PEVC ride-sharing supply;
assigning, by the processor set, an identified PEVC carrier to deliver a PEVC unit to a target PEVC end user;
transmitting, by the processor set, at least one delivery instruction to the assigned PEVC carrier and the target PEVC end user; and
receiving, by the processor set, a confirmation message from the assigned PEVC carrier that the PEVC unit was delivered to the target PEVC end user.

2. The computer-implemented method of claim 1, further comprising identifying the target PEVC end user and the PEVC carrier based on the received EV data, wherein the PEVC carrier is selected from a plurality of potential PEVC carriers.

3. The computer-implemented method of claim 2, further comprising sending at least one PEVC demand requirement and at least one PEVC ride-sharing supply to the identified target PEVC end user and the PEVC carrier.

4. The computer-implemented method of claim 1, further comprising transmitting a signal to the PEVC unit to enable running time charging by the PEVC unit.

5. The computer-implemented method of claim 1, further comprising receiving confirmation from the target PEVC end user that the PEVC unit has been returned to a PEVC service provider.

6. The computer-implemented method of claim 5, further comprising calculating transactional data for the assigned PEVC carrier and the target PEVC end user in response to receiving confirmation from the target PEVC end user that the PEVC unit has been returned to a PEVC service provider.

7. The computer-implemented method of claim 6, further comprising processing transactional information for the assigned PEVC carrier and the target PEVC end user based on the calculated transactional data.

8. The computer-implemented method of claim 1, further comprising normalizing the received EV data to match a predetermined data structure.

9. A computer program product comprising one or more computer readable storage media having program instructions collectively stored on the one or more computer readable storage media, the program instructions executable to:
receive electric vehicle (EV) data describing at least one connected electric vehicle and at least one portable electric vehicle charging (PEVC) unit;
analyze the received data to determine at least one PEVC demand requirement and at least one PEVC ride-sharing supply;
assign an identified PEVC carrier to deliver a PEVC unit to a target PEVC end user;
transmit at least one delivery instruction to the assigned PEVC carrier and the target PEVC end user; and
receive a confirmation message from the assigned PEVC carrier that the PEVC unit was delivered to the target PEVC end user.

10. The computer program product of claim 9, wherein the program instructions are further executable to:
identify the target PEVC end user and the PEVC carrier based on the received EV data, wherein the PEVC carrier is selected from a plurality of potential PEVC carriers; and
send at least one PEVC demand requirement and at least one PEVC ride-sharing supply to the identified target PEVC end user and the PEVC carrier.

11. The computer program product of claim 9, wherein the program instructions are further executable to transmit a signal to the PEVC unit to enable running time charging by the PEVC unit.

12. The computer program product of claim 9, wherein the program instructions are further executable to:
receive confirmation from the target PEVC end user that the PEVC unit has been returned to a PEVC service provider; and
calculate transactional data for the assigned PEVC carrier and the target PEVC end user in response to receiving confirmation from the target PEVC end user that the PEVC unit has been returned to a PEVC service provider.

13. The computer program product of claim 12, wherein the program instructions are further executable to process transactional information for the assigned PEVC carrier and the target PEVC end user based on the calculated transactional data.

14. The computer program product of claim 9, wherein the program instructions are further executable to normalize the received EV data to match a predetermined data structure.

15. A system comprising:
a processor set, one or more computer readable storage media, and program instructions collectively stored on the one or more computer readable storage media, the program instructions executable to:
receive electric vehicle (EV) data describing at least one connected electric vehicle and at least one portable electric vehicle charging (PEVC) unit;
analyze the received data to determine at least one PEVC demand requirement and at least one PEVC ride-sharing supply;
assign an identified PEVC carrier to deliver a PEVC unit to a target PEVC end user;
transmit at least one delivery instruction to the assigned PEVC carrier and the target PEVC end user; and
receive a confirmation message from the assigned PEVC carrier that the PEVC unit was delivered to the target PEVC end user.

16. The system of claim 15, wherein the program instructions are further executable to:
identify the target PEVC end user and the PEVC carrier based on the received EV data, wherein the PEVC carrier is selected from a plurality of potential PEVC carriers; and
send at least one PEVC demand requirement and at least one PEVC ride-sharing supply to the identified target PEVC end user and the PEVC carrier.

17. The system of claim 15, wherein the program instructions are further executable to transmit a signal to the PEVC unit to enable running time charging by the PEVC unit.

18. The system of claim 15, wherein the program instructions are further executable to:
receive confirmation from the target PEVC end user that the PEVC unit has been returned to a PEVC service provider; and
calculate transactional data for the assigned PEVC carrier and the target PEVC end user in response to receiving confirmation from the target PEVC end user that the PEVC unit has been returned to a PEVC service provider.

19. The system of claim 18, wherein the program instructions are further executable to process transactional information for the assigned PEVC carrier and the target PEVC end user based on the calculated transactional data.

20. The system of claim 15, wherein the program instructions are further executable to normalize the received EV data to match a predetermined data structure.
